(19) United States
(12) Patent Application Publication
(10) Pub. No.: US 2015/0371237 A1
(43) Pub. Date: Dec. 24, 2015

(54) ONE TOUCH CUSTOMER SERVICE

(71) Applicant: THOMSON LICENSING, Issy de Moulineaux (FR)

(72) Inventor: Steven Lee Cooper, Whitestown, IN (US)

(21) Appl. No.: 14/736,662

(22) Filed: Jun. 11, 2015

Related U.S. Application Data
(60) Provisional application No. 62/014,276, filed on Jun. 19, 2014.

(51) Int. Cl. G06Q 30/00; G06F 3/0484; G06F 3/0482

(52) U.S. Cl. CPC G06Q 30/016; G06F 3/0482; G06F 3/04842

(57) ABSTRACT

A method and system for customer support, wherein a request for customer support is sent via user device comprising a one-touch button for initiating contact with the customer support center. A customer support center receives the request and can initiate communications with a user. The means of communication between the customer support center and the user is based on user information sent with the request.

### BACKGROUND

In recent years, telephonic customer support centers have become integral to many businesses economic role is significant and growing. They have become the preferred means for companies to communicate with their customers. Most companies with customer contact have reengineered their framework to include call centers, either internally managed or outsourced. For many companies, such as credit card companies, product manufacturers, and internet based companies, call centers provide a primary link between customer and service products. Typically, if a client calls such a business, a voice prompt menu allows the calling client to identify the issue for which the client requires service. The client is then transferred to the appropriate department or queued for a service agent capable of dealing with the specific issue identified. For example, clients who identify the purpose of their call as “customer support” will be connected to or queued for a service representative with the ability to provide customer support. The clients are then left waiting for an available customer service representative for an unknown period of time causing frustration to the clients.

Sorting through the different menu prompts or waiting for an available customer service representative has led to customer dissatisfaction. Therefore, companies have invested a significant amount of money and effort in improving customer support centers. Some of these technologies include personalized greetings, interactive voice response (IVR) platforms, text mining, speech recognition and natural language processing, support automation and many other technologies to improve customer satisfaction. One solution customer support centers have implemented is a call back system. The call back system allows a client to enter a telephone number as a contact number where the client can be reached when a customer service representative is available. The client call is then disconnected. Once a customer service representative is available, the call back system places a call to the client via the provided telephone number and connects the client to an available representative. Therefore, the customer does not have to be placed on hold or in a queue.

However, this solution does not alleviate a client's frustration in having to find the customer service phone number and navigating through various layers of a menu. Therefore, there is a need for a method and system for a one touch solution for automatically contacting a customer service center and providing the customer service center with contact information such as a call back number.

### SUMMARY

To address the challenges of contacting a customer support center, a one-touch solution for communicating with a customer service center is used. In one embodiment, the method includes receiving a request for customer service support and user information, the request being activated by a one touch button of the user device and in response to the request, and initiating communication channel between a customer service agent and communication device. The communication channel is determined by the received user information.

### BRIEF DESCRIPTION OF THE FIGURES

FIG. 1 is a block diagram illustrating one-touch customer support system according to one embodiment.

FIG. 2 is a flow diagram illustrating a method for providing customer support according to one embodiment.

FIG. 3 is an illustration of a user device having a one touch button.

FIG. 4 is a flow diagram illustrating a method for providing customer support services according to one embodiment.

### DETAILED DESCRIPTION

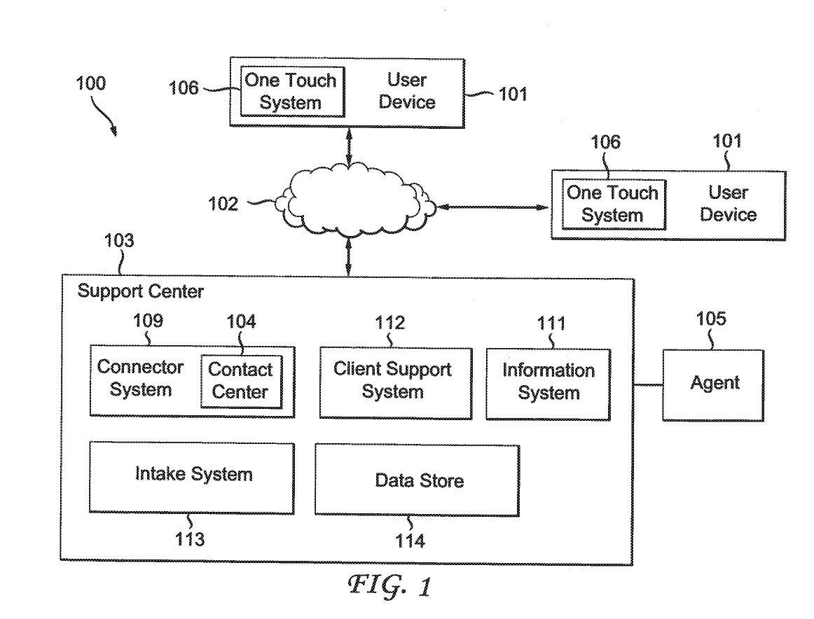

FIG. 1 is a block diagram illustrating a one-touch support service system according to one embodiment. Referring to FIG. 1, system 100 includes a user device 101 communicatively coupled to support center 103 over network 102. Network 102 can be a packet switched network (e.g., local area network or LAN, metropolitan area network or MAN, a wide area network or WAN, a campus area network or CAN or the Internet), a circuit switched network, a voice over IP telephony network, a cellular network, or the like. The user device 101 can be any kind of device having a network connection, including, but not limited to, a cable box, a smartphone, a cell phone, a laptop, a desktop, tablet, personal digital assistant, a modem (such as, DSL or Cable), or the like. Although only two user device is shown in FIG. 1, multiple user devices can also be used.

Support center 103 receives communications from a user at the contact center 104, The user communicates with the support center 103 through a one touch button 106 on a user device 101, a controller associated with the user device 101, or a communication device associated with the user. Support center 103 provides support for products or support for services. The support center can handle customer service requests for a number of cable distribution companies, fiber optic distribution companies, and internet service providers.

In one embodiment, the support center 103 can further include an information system 111, an intake system 113, and a client support system 112. The information system 111 processes the data transferred from the user device, a mechanism associated with the user device, or communication device to the support center. In another embodiment, the information processed by the data transferred from the user device can be stored in the data store 114 or compared to data in the data store 114. The data store can store and/or map information related to a user or a product/service, such as user ID, product/service details as related to the user, product manuals or warranties for the product/services, user contact information, receipts, store information, and the like.

The intake system 113 prioritizes calls based on one or many various circumstances, including but not limited to, the emergency status of a call, the call time, availability of agents 105, or subject of the call. In an embodiment, the intake system 113 provides a caller queue. The client support system 112 is responsible for the support services requests from the users, including troubleshooting request via a one touch button 106. The one-touch button 106 can be a physical button located on the user device 101 or a controller of the device, or a GUI button on a display screen which can be activated through a touching, tapping or clicking of the button via a touch screen display, a mouse, touchpad, remote controller or the like.

Support center 103 further comprises a connector system 109 to provide multiple connections between a plurality of users and a support center 103 or an agent 105 to initiate contact with the user, Each connection provides a communication channel between the user and the support center, and includes, but is not limited to, email, chat, texting, SMS, voice, video, or web conferencing. In an embodiment, information from the data store 114 can be sent to the user via the connector system 109. The agent 105 can be notified by the intake system 113 the identity of the user. The agent 105 can be a live agent, a computerized agent, a computerized receptionist, and interactive voice response system or the like.

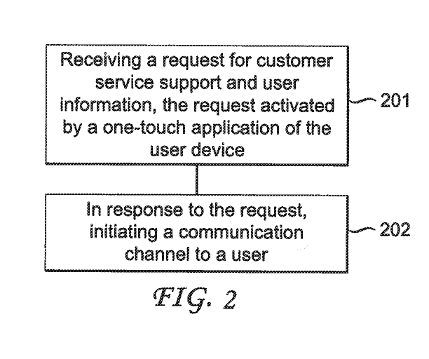

FIG. 2 is a flow diagram illustrating a method for providing customer support services according to an embodiment. For example, method 200 can be performed by system 100 of FIG. 1. Referring to FIG. 2, at block 201, a customer support center receives a request for customer support and user information. This request and user information is sent to the customer support center once a user activates a one-touch button to request customer support. Once activated, the user information is automatically sent to the customer support center by the user device. The user information can provide information regarding the user, such as name, user ID, contact information, or the like, and/or information regarding the product or service at issue.

In an embodiment, the information regarding product or services at issue can automatically send, to the customer support center, device details such as a model number, serial number, mobile equipment identifier (MEID) or a media access control (MAC) address. The customer support system can cross-reference the information regarding product or services via a device registration system, a payment system or any other system relating the product or service, the user identification and/or the user contact information.

In one embodiment, the user information can be entered into the user device by the user via a menu, electronic form, an application, or any other data entry means. The user information could also be mined from a given website with a provided user ID or the like. For example, a social networking site can provide user contact details for a given user ID. The device itself can have its own social networking affiliation wherein the users, each having a unique user ID, can be affiliate or member of the device's social network profile.

In another embodiment, on devices such as smartphones or voice over internet protocol (VOIP) products, the user information can be downloaded onto the device if it has been registered to the service provider. For example, when a cable modem or cable box subscriber receives their device, they must call the service center and provide the unique device identification, such as MEID or MAC address. The service provider can associate the unregistered device on their network to the customer, and register the device in their system. At that point, details, such as phone numbers, uniform resource identifiers, ringtones, data rates, or the like, are sent to the device over the network. Thus, the device itself knows the user contact information. Even if this information is not downloaded to the device, upon pressing the support button, the device's unique identifier can be sent to the customer service center and the customer service center could perform a cross reference of their customer database to obtain the information before forwarding the support request to the support center.

At block 202, once a request for customer support and user information is received by the customer service center, a communication channel to a user can be initiated. In one embodiment, the customer service agent initiates communication to the user via a communication means. The communication means can include voice communication means, e-mail, text, SMS, or the like. A connection between the customer service agent and the user can be established according to the received user information via the selected communication means. In another embodiment, if the preferred communication means is not provided in the user information, a default communication means can be selected between the customer and an agent that has previously been associated with the user or the product/service.

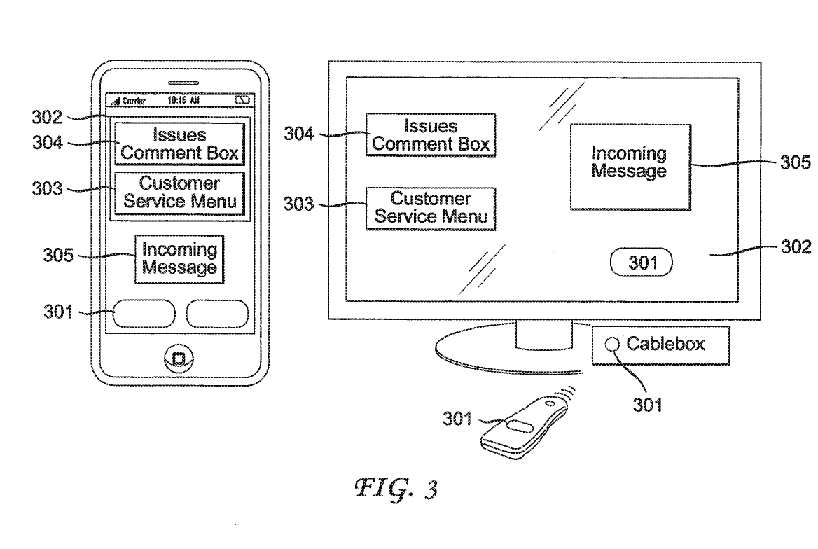

FIG. 3 illustrates a user device having a one touch button. A user device can be: a user communication device, such as a cellphone or smartphone; a display device that has networking capabilities, such as a tablet, touch screen devices, a display monitor such as a television or a smart television; a device controller such as a remote control; a cablebox, a modem or any device that transmits and receives signals; or the like. As described above, when the one-touch button 301 is activated, the one-touch button 301 is configured to communicate with the support center via a network. A user can activate a button by tapping, touching or pressing on a button 301. Once the button is activated, the user device can send personal information to a customer service center. In some embodiments, activating the button 301 can also include providing information that can include a log in and access to the user's account. In an exemplary embodiment, once the button is activated, a menu or service screen 302 can be presented to the user. The menu or service screen 302 can be a GUI or a webpage design. The menu or service screen 302 can allow the user to enter any user specific information via a selection menu 303 or a comment page 304. For example, a user can select a reason for the customer support request via the menu 303 or type the reason for the customer support request via the comment page 304.

In one embodiment, a user device can be a modem, such as a cable or DSL modem. The modem can be either wirelessly connected or hardwired to a display screen. A user, looking to contact the customer service center, can access a webpage displayed on the display screen. The modem will redirect the user to a web page served internally on the modem. The user can access this web page from any device on their home network which provides a web browser. The web page includes a one-touch customer support button on its main screen. The user can activate this button by touch or click on the button.

In one embodiment, a user can also specify a means of communication by activating the corresponding preference item from the list displayed on the menu 303. For example, via the menu 303 or comment page 304, the user can specify one or more preferred means to communicate, such as voice, chat, email, and other channels or a preferred contact number. Such preferences of the user can be used to determine availability of means to communicate to allow the user to reach the support center during a subsequent support service.

In one embodiment, the product detailed information can be retrieved from the support center and displayed on the user device that requested the customer service 305. The displayed product detailed information can comprise a product manual, customer service queue time, product warranty information, frequently asked questions, troubleshooting information, etc. In addition, the display can further include one or more links to allow a user to access other information associated with the corresponding product.

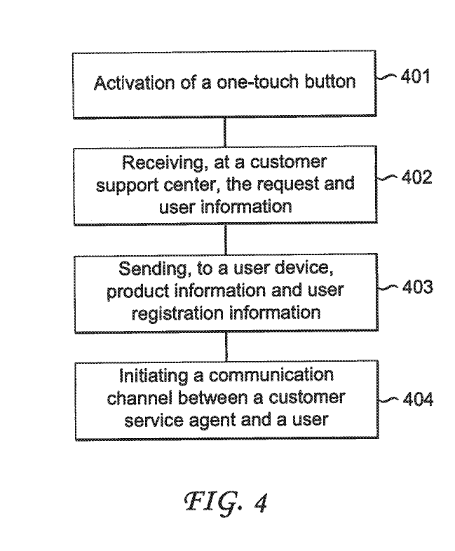

FIG. 4 is a flow diagram illustrating a method for providing customer support services according to one embodiment. For example, method 400 can be performed by system 100 of FIG. 1. Referring to FIG. 4, at block 401, a user can activate a one-touch button to request customer support. The one-touch button can be a physical button located on the user device or a button on a display screen which can be activated through a touching or tapping on the display screen button or by clicking on the button via a mouse, touchpad, or the like. In one embodiment, a one-touch button can be downloaded from an application store and installed on a user device of a customer.

Once the user has activated a one touch button or button to request customer service, at block 402, the customer support center receives the request and user information. The user information is automatically sent to the customer support center by the user device in response to the activation of the customer support request. The user information can comprise one or a combination of preferred contact number, user device information, user identification number, e-mail address, preferred contact medium, user statistical information, user behavior history, or the like. The receipt of the customer service request can authorize the customer service center to perform preliminary diagnostic testing on the user device prior to contacting the customer. The preliminary diagnostic testing can be done by a customer service agent or device via the network, a virtual private network, or the like.

In another embodiment, via the one touch button, a user device can transmit a machine-readable code associated the user information to the customer support center, such as a personal ID, that uniquely identifies the user. The one-touch button can also provide the support center a device ID that uniquely identifies the user device, such as, the product or service related to the customer support need. Such information can be subsequently utilized to authenticate the customer automatically, without requiring the customer to specifically provide the same information for the purposes of authentication.

At block 403, the user device can retrieve information from the support center concerning all of the products and information associated with the customer that has been registered with the support center. In one embodiment, the one-touch button is configured to display on a display of the user device a customer support page. The customer support page can indicate the availability of the means to communicate and other information relating to the product and/or troubleshooting information. The availability of the means to communicate can be determined and compiled based on the user's preferences.

At block 404, a request for customer support and user information is received by the customer service center, a communication channel between the user and a customer service agent can be initiated. In one embodiment, the available means to communicate and a connection will be established according to the received user information. In another embodiment, if the preferred communication channel is not provided in the user information, a default communication means can be selected between the customer and an agent.

According to the inventive principles as disclosed in connection with the preferred embodiment and other embodiments, the invention and the inventive principles are not limited to any particular kind of user device or customer service center devices, but can be used with any general purpose communication products, as would be known to one of ordinary skill in the art, arranged to perform the functions described and the method steps described.

In an embodiment, some or all of the method components are implemented as a computer executable code. Such a computer executable code contains a plurality of computer instructions that when performed in a predefined order result with the execution of the tasks disclosed herein. Such computer executable code can be available as source code or in object code, and can be further comprised as part of, for example, a portable memory device or downloaded from the Internet, or embodied on a program storage unit or computer readable medium. The principles of the present invention can be implemented as a combination of hardware and software. Additionally, because some of the constituent system components and methods depicted in the accompanying drawings can be implemented in software, the actual connections between the system components or the process function blocks can differ depending upon the manner in which the present invention is programmed.

The computer executable code can be uploaded to, and executed by, a machine comprising any suitable architecture. Preferably, the machine is implemented on a computer platform having hardware such as one or more central processing units (“CPU”), a random access memory (“RAM”), and input/output interfaces. The computer platform can also include an operating system and microinstruction code. The various processes and functions described herein can be either part of the microinstruction code or part of the button program, or any combination thereof, which can be executed by a CPU, whether or not such computer or processor is explicitly shown. In addition, various other peripheral units can be connected to the computer platform such as an additional data storage unit and a printing unit.

The functions of the various elements shown in the figures can be provided through the use of dedicated hardware as well as hardware capable of executing appropriate software. When provided by a processor, the functions can be provided by a single dedicated processor, by a single shared processor, or by a plurality of individual processors, some of which can be shared. Explicit use of the term “processor” or “controller” should not be construed to refer exclusively to hardware capable of executing software, and can implicitly include, without limitation, digital signal processor hardware, ROM, RAM, and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments, as well as specific examples thereof, are intended to encompass both structural and functional equivalents thereof. It is intended that such equivalents include both currently known equivalents as well as equivalents developed in the future, i.e., any elements developed that perform the same function, regardless of structure.

While the foregoing has been described in some detail for purposes of clarity and understanding, it will be appreciated by one skilled in the art, from a reading of the disclosure that various changes in form and detail can be made without departing from the true scope of the invention.

1. A method for customer support, the method comprising:
receiving user information and a request for customer service support, the request activated by a one-touch button of a user device; and
in response to the request, initiating a communication channel by a customer support center, the communication channel determined by the user information.

2. The method of claim 1, wherein the user information is sent to the customer support center upon activation of the one-touch button of the user device.

3. The method of claim 2, wherein the user information is not entered prior to activation of the one-touch button of the user device.

4. The method of claim 1, further comprising:
performing a diagnostic test on the user device prior to responding to the request.

5. The method of claim 4, wherein the user information includes authorization to perform the diagnostic test on the user device.

6. The method of claim 1, wherein the user device displays a customer service menu upon activation of the one-touch button, the customer service menu comprising a list of customer service issues.

7. The method of claim 6, wherein the request for support is received in response to a selection of one of the issues in the list.

8. The method of claim 1, wherein the user device displays a customer service dialog box.

9. The method of claim 1, wherein the user device is a mobile device.

10. The method of claim 1, wherein the user device is at least one of a gateway device and a set top box device.

11. A non-transitory computer readable media comprising program code that when executed by a programmable processor causes the processor to execute a method for customer support, the computer readable media comprising:
a program code receiving user information and a request for customer service support, the request activated by a one-touch button of a user device; and
in response to the request, a program code initiating a communication channel by a customer support center, the communication channel determined by the user information.

12. The program code of claim 11, wherein the user information is sent to the customer support center upon activation of the one-touch button of the user device.

13. The program code of claim 12, wherein the user information is not entered prior to activation of the one-touch button of the user device.

14. The program code of claim 11, further comprising:
a program code performing a diagnostic test on the user device prior to responding to the request.

15. The program code of claim 14, wherein the user information includes authorization to perform the diagnostic test on the user device.

16. The program code of claim 11, wherein the user device displays a customer service menu upon activation of the one-touch button, the customer service menu comprising a list of customer service issues.

17. The program code of claim 16, wherein the request for support is received in response to a selection of one of the issues in the list.

18. The program code of claim 11, wherein the user device displays a customer service dialog box.

19. The program code of claim 11, wherein the user device is a mobile device.

20. The program code of claim 11, wherein the user device is at least one of a gateway device and a set top box device.
